(19) United States
(12) Patent Application Publication
(10) Pub. No.: US 2006/0279770 A1
(43) Pub. Date: Dec. 14, 2006

(54) PRINTING SYSTEM AND METHOD

(76) Inventor: JUN-HO JEON, Daegu (KR)

Correspondence Address: IPLA P.A., 3580 WILSHIRE BLVD., 17TH FLOOR, LOS ANGELES, CA, 90010, US

(21) Appl. No.: 11/162,440

(22) Filed: Sep. 9, 2005

(30) Foreign Application Priority Data
Jun. 10, 2005 (KR) 10-2005-0050041

(51) Int. Cl. G06F 3/12

(52) U.S. Cl. 358/1.15; 358/1.13

(57) ABSTRACT

The printing system in accordance with the present invention includes a computer with a print setup program displaying a print command window on a monitor screen and at least one printer, each with two or more paper source cassettes, connected to the computer, wherein the print setup program detects all the printers connected to the computer and all the paper source cassettes provided to each printer and provides a number of print command execution buttons corresponding to the detected cassettes in the print command window, to let a user to select any button among the print command execution buttons, so that a user can print out from a desired cassette.

### BACKGROUND OF THE INVENTION

1. Field of the Invention

The present invention relates to a printing system, and more particularly to a printing system, wherein a plurality of paper source cassettes, into which different sizes of papers, different qualities of papers, clean papers and half-sheet papers are loaded separately and respectively, is provided and further a printing command window with a plurality of printing command execution buttons is provided, so that a print out is performed using papers in a desired paper source cassette among the paper source cassettes by simply clicking a print command execution button corresponding to the desired paper source cassette.

2. Description of the Related Art

As electric and electronic industries are developed, various kinds of electric and electronic machines have been produced.

Among such electric and electronic machines, computers and printers are the most rapidly spread out into our daily life, so that they become a familiar part of our life.

Now days, such a printing means generally employs a plurality of paper source cassettes to allow users to selectively use different sizes and different qualities of papers as desired. Such a “printing device” (hereinafter, referred as a “printer”) can be connected to “a computer or an electronic computing device” (hereinafter, referred as a “computer”) via a network. Further, a plurality of printers can be connected to one computer.

However, with reference to FIG. 1 and FIG. 2, in a computer connected to a plurality of printers, a print command window provided by an application program installed in the computer includes a printer selection sub-window allowing a user to select one printer among many printers connected to the computer, thereby printing out using the user's desired printer. In case that the printer is equipped with a plurality of paper source cassettes, a user has to go to the selected printer and select one of the cassettes to use by operating buttons provided to the printer, and then the user can finally print out by clicking a print command execution button in the printing command window.

In case that a computer is connected to a plurality of printers and each printer is equipped with a plurality of paper source cassettes as described above, a conventional printing method is as follows:

First, if a user clicks a print command execution button provided by a corresponding program being used by the user and a print command is executed, a print command window is displayed on a monitor screen of the computer as shown in FIG. 1 and FIG. 2, then a user selects a desired printer through a printer selection window in the printing command window as shown in FIG. 3, and then selects a desired cassette from the desired printer. Then, all the settings are stored in a storage unit as a printing environment and the user can print out by clicking a button noted as “print” in the printing command window using the papers loaded in the desired cassette of the desired printer.

Such a conventional printing out method is disadvantageous in that although the printer has a plurality of paper source cassettes, each being loaded with a different size of paper or a different quality of paper, but the same cassette of the same printer which is initially selected by default setting is continuously used, so that deterioration of one paper source cassette of the one printer is expedited. Further, although it is possible to load unused papers and half-sheet papers separately into different cassettes, half-sheet papers are not actively used due to the complicated and troublesome cassette selection procedure.

### SUMMARY OF THE INVENTION

Accordingly, it is a feature of the present invention to solve at least the problems and disadvantages of the related art.

It is a feature of the present invention to provide a printing system providing a user with a print command window with a plurality of print command execution buttons as many as the number of paper source cassettes to allow a user to directly select a cassette to use at the user's site using the print command window, thereby easily printing using papers loaded in the desired paper source cassette by just clicking the print command execution button which is noted as a term “print” in the print command window.

To achieve such features of the present invention, there is provided a printing system including at least one printer equipped with two or more paper source cassettes, wherein the printer prints out by being controlled by a print control signal transmitted from a computer having a print control program therein, which displays a print command window on a monitor screen thereof, and wherein the print control program detects all the printers connected to the computer and all the paper source cassettes provided to each printer and displays a number of print command execution buttons as many as the number of the detected cassettes within the print command window, to let a user to select any button among the print command execution buttons, thereby printing out from the desired paper source cassette.

### BRIEF DESCRIPTION OF THE DRAWINGS

The invention will be described in detail with reference to the following drawings in which like numerals refer to like elements and in which;

FIG. 1 is a print command window controlled by a conventional printing system and provided by a conventional Internet browser in accordance with the related art;

FIG. 2 is a print command window controlled by a conventional printing system and provided by a conventional word processing program in accordance with the related art;

FIG. 3A to FIG. 3B are flow charts for showing order of print command execution steps in accordance with the related art;

FIG. 4 is a print command window controlled by a printing system in accordance with the present invention and provided by an Internet browser;

FIG. 5 is a print command window controlled by a printing system in accordance with the present invention and provided by a word processing program; and

FIG. 6A and FIG. 6B are flow charts showing order of print command execution steps in accordance with the present invention.

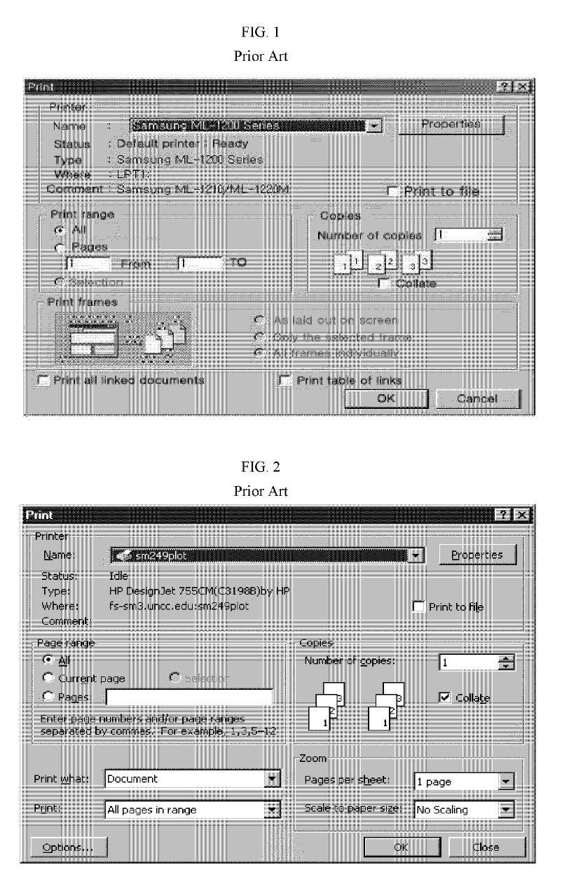

### DETAILED DESCRIPTION OF THE PREFERRED EMBODIMENTS

Preferred embodiments of the present invention will be described in a more detailed manner with reference to the drawings.

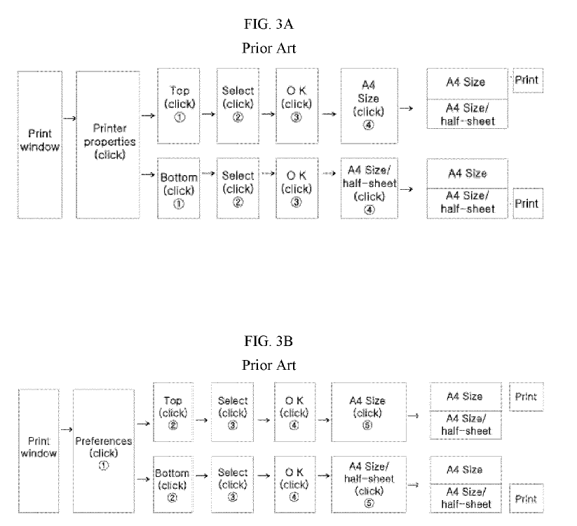

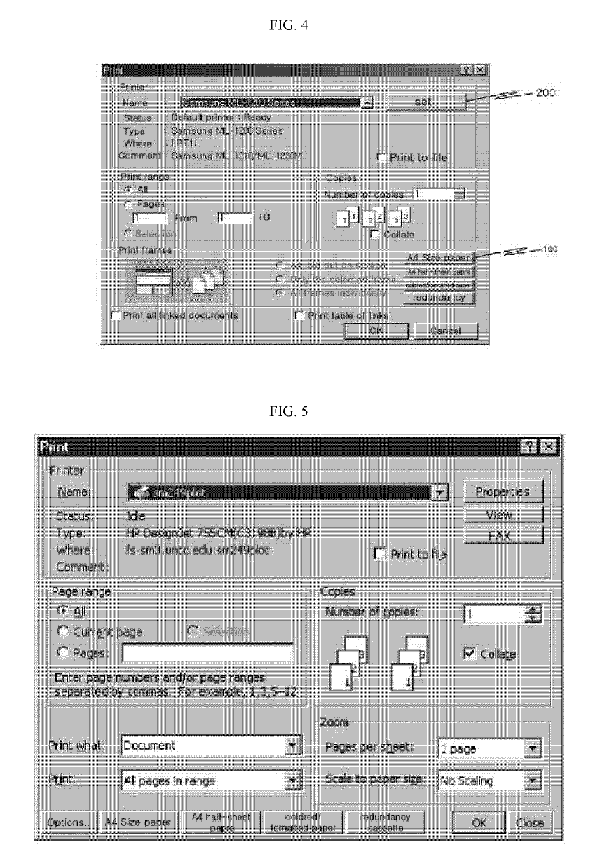

FIG. 3 is an exemplary print command window provided by an Internet browser on a monitor screen of a computer which is controlled by a printing system in accordance with the present invention, and FIG. 4 is an exemplary print command window provided by a word processing program on a monitor screen of a computer which is controlled by a printing system in accordance with the present invention.

As shown in drawings, the printing system in accordance with the present invention has the print command window with a plurality of print command execution buttons 100, each of which transmits a print command to the corresponding paper source cassette of a printer.

The print command execution buttons 100 are set by a print setup program, and the print setup program detects all the printers connected to the computer having the print setup program installed therein and all the paper source cassettes provided to each of the printers.

When the printers are detected, the print setup program checks the number of paper source cassettes provided to the corresponding printer by detecting the paper source cassettes, and displays a plurality of print command execution buttons 100 within the print command window, wherein the number of print command execution buttons 100 is identical to the number of detected paper source cassettes.

Each print command execution button 100 transmits a print out signal to the corresponding paper source cassette of the corresponding printer so that print out can be done from the designated paper source cassette.

The print command window having the print command execution buttons 100 also has a printer display window. The printer display window shows names of the printers connected to the computer. The print command window further has a printer setup button 200.

The printer setup button 200 is provided for default setting of the printer displayed in the printer display window. When the printer setup button 200 is clicked, information on the printer displayed in the printer display window and a default setup screen are displayed, thereby allowing a user to select a paper size, a print effect, a print quality, a direction of paper, and so on, and the print setup value is linked with the print command execution button 100, thereby performing print-out.

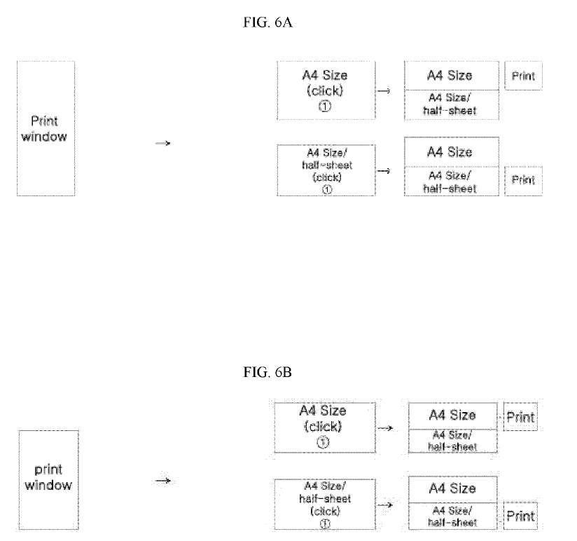

As described above, as the print command execution buttons 100 are provided within the print command window, it is possible to directly transmit a print command to each paper source cassette of a printer. Accordingly, as shown in FIG. 6A and FIG. 6B, printing can be done from the desired paper source cassette of the desired printer without directly giving any operation with respect to the printers.

In accordance with the present invention, since the number of print command execution buttons which transmits print commands to the paper source cassettes for each printer are identical to the number of paper source cassettes, print-out can be easily done from the desired paper source cassette by just clicking the corresponding print command execution button. As a result, a paper source cassette to print out can be easily selected and set up.

Further, since it is possible to easily select the desired paper source cassette to print out, it is also easy to print out from a paper source cassette in which half-sheet papers are loaded, thereby encouraging people to use half-sheet papers and preventing waste of natural resource.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A printing system, comprising:
a print setup program installed in a computer for displaying a print command window on a monitor screen of the computer; and
one or more printers connected to the computer and equipped with two or more paper source cassettes for printing out from a paper source cassette among the paper source cassettes by receiving a print setup signal transmitted from the computer,
wherein the printing system detects the printers connected to the computer and the paper source cassettes employed in the detected printer and provides a plurality of print command execution commands corresponding to the paper source cassettes which are detected to within the print command window, and wherein the print command execution buttons make the corresponding paper source cassettes, respectively, to print out.

2. The printing system according to claim 1, wherein the print command window additionally includes a printer display window which is provided with a setup button for setting up a property of a printer represented on the printer display window, so when the setup button is clicked information on the printer represented in the printer display window and a default setup window for setting up properties of the printer represented in the printer display window are displayed, thereby allowing a user to set paper size, print effect, print quality, and paper direction, and wherein when the print command execution button is clicked, the printer prints out in accordance with a print set value which is set using the printer display window.
